(19) United States
(12) Patent Application Publication
(10) Pub. No.: US 2015/0281525 A1
(43) Pub. Date: Oct. 1, 2015

(54) EXTENDABLE CAMERA

(71) Applicant: Anshuman Thakur, Beaverton, OR (US)

(72) Inventor: Anshuman Thakur, Beaverton, OR (US)

(21) Appl. No.: 14/228,623

(22) Filed: Mar. 28, 2014

(51) Int. Cl. H04N 5/225

(52) U.S. Cl. CPC H04N 5/2251

(57) ABSTRACT

An extendable imager configured to capture an image responsive to a command from a mobile device and an arm coupled to the imager, the arm configured to extend the imager from a surface of the mobile device.

### TECHNICAL FIELD

Examples described herein generally relate to methods, systems, and devices to provide an extendable camera for a mobile device.

### BACKGROUND

In an environment with an obstructed viewpoint such as in a crowd at a concert, a political speech or a graduation ceremony a person attempting to capture an image or audio may have to lift their arms high up to capture such image or audio with a camera/microphone equipped mobile device. Taking pictures/videos/recording audio in this posture poses a number of problems for the person taking the picture/video/audio as well as people around them. For example, it is extremely tedious and uncomfortable to hold one's arm in the air for long periods of time. It is difficult to point and focus the camera/video recorder/audio recorder from this position because the video screen may not be visible. Additionally, a user may block other people's view while holding their arm up in an attempt to capture video in a crowded environment.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates an example of a mobile device configured to extend an imager to capture an image;

FIG. 2 illustrates an example of a mobile device comprising an extendable imager;

FIG. 3 illustrates an example of an extendable imager;

FIG. 4 illustrates an example of a mobile device comprising an extendable imager;

FIG. 5 illustrates an example of a mobile device comprising an extendable imager;

FIGS. 6A-6B illustrate examples of a mobile device configured to extend and/or retract an imager;

FIGS. 7A-7C depict various examples ranges of motion of an imager coupled to a mobile device;

FIGS. 8A-8C illustrate a few of many possible examples of various extendable imager assemblies;

FIG. 9 illustrates a process for controlling functions of an extendable imager coupled to a mobile device via an extendable arm for capturing an image and/or audio with imager.

### DETAILED DESCRIPTION

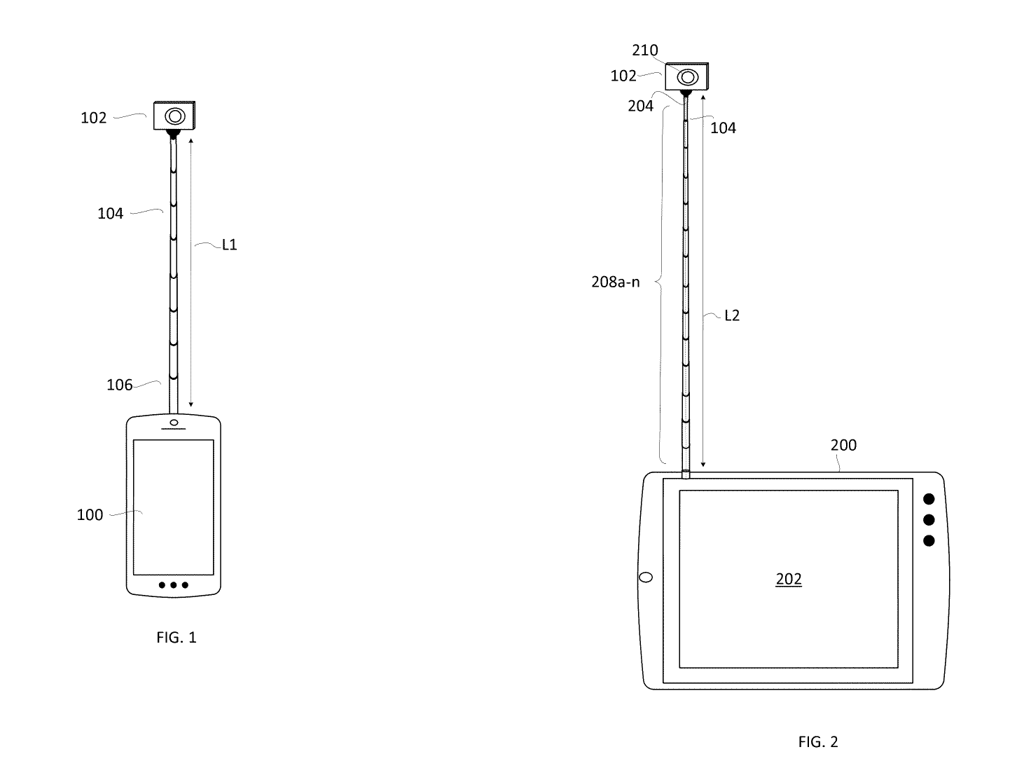

FIG. 1 illustrates an example of a mobile device 100 configured to extend an imager 102 to capture an image. In an example, imager 102 may be coupled to an arm 104. Arm 104 may be coupled to mobile device 100 and may be configured to extend imager 102 outwardly from a surface 106 of mobile device 100 a length L1. Such extension may facilitate capture of an image and/or audio from an extended height. L1 may be any length feasible. Mobile device 100 may comprise a mobile phone. In another example, mobile device 100 may comprise any of a variety of mobile devices, such as, a tablet, a notebook, a detachable slate device, an Ultrabook™ system, a wearable communications device, a personal computer and/or the like or a combination thereof.

In an example, imager 102 may form at least a portion of a camera incorporated into mobile device 100. In another embodiment, imager 102 may be configured to attach to mobile device 100 as an accessory.

FIG. 2 illustrates an example of a mobile device 200 comprising an extendable imager 102. Mobile device 200 may be a tablet device. In another example, mobile device 200 may be any of a variety of mobile devices, such as, a mobile phone, a notebook, a detachable slate device, an Ultrabook™ system, a wearable communications device, a personal computer and/or the like or a combination thereof.

In an example, arm 104 may be configured to support imager 102 and may comprise a variety of materials such as titanium, aluminum, steel, carbon fiber, plastic, fiberglass, metal alloy and/or other material, or a combination thereof. Arm 104 may be configured to extend imager 102 a length L2. L2 may be any feasible length. Arm 104 may be configured to extend and/or retract. For example, arm 104 may be a telescoping device wherein arm 104 comprises two or more sections 208a-n configured to fit and slide within one another to extend and/or retract.

In an example, imager 102 may be controlled mobile device 200 and may receive control commands from mobile device 200 via wire line and/or wireless communications. Such commands may be configured to trigger various actions to be executed by imager such as image and/or audio capture, data transfer, movement or the like or a combination thereof. Imager 102 may communicate image data, status data, position data, sensor data, and/or the like or a combination thereof to mobile device 200 via wire line and/or wireless communications. Mobile device 200 may process image data, status data, position data, sensor data, and/or the like or a combination thereof received from imager 102. Mobile device 200 may store image data and/or display image data on display 202.

In an example, arm 104 may comprise an insulated conductive wire 204 configured to enable communication between imager 102 and mobile device 200. Conductive wire 204 may comprise a variety metals such as copper, gold, aluminum and/or the like or a combination thereof.

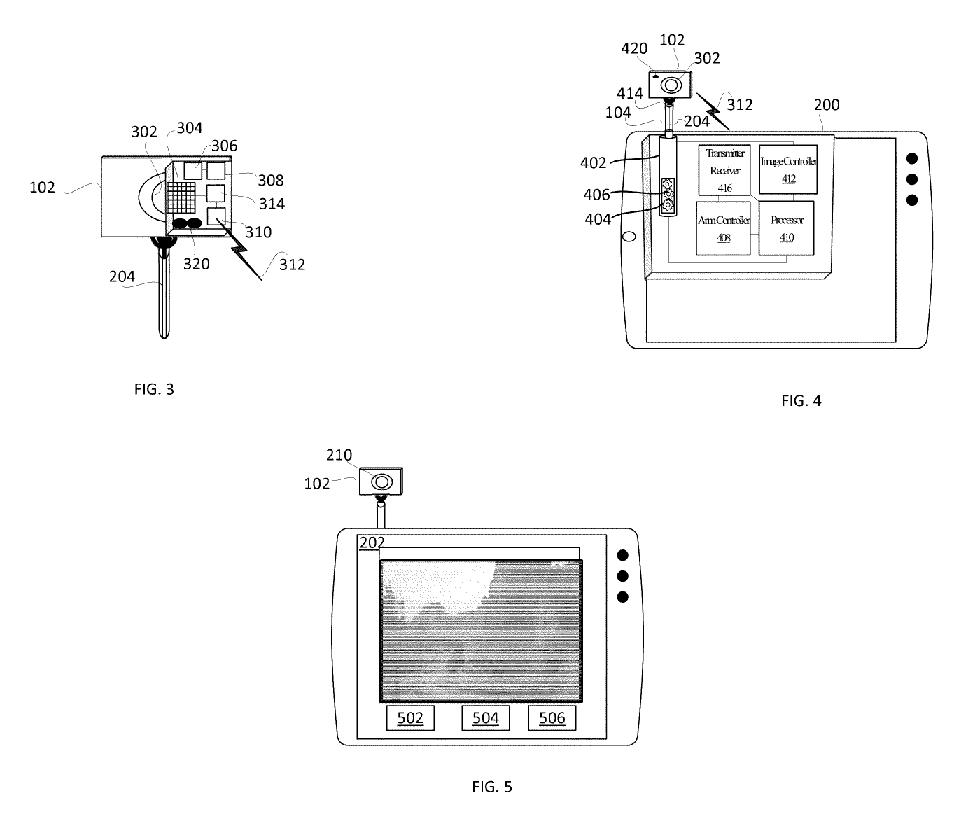

FIG. 3 illustrates an example of an extendable imager 102. In an example, imager 102 may include any of a variety of devices configured to capture an image. For example, imager 102 may comprise a lens 302 and an image sensor 304. Image sensor 304 may comprise at least one of a complementary metal-oxide-semiconductor (CMOS) sensor, an n-channel metal-oxide-semiconductor field-effect transistor (NMOS) sensor, a live metal-oxide-semiconductor field-effect transistor (MOS) sensor, charge-coupled device (CCD) sensor, thermal image sensor, infra-red (IR) image sensor, or the like or a combination thereof.

In an example, imager 102 may comprise a transmitter and/or receiver 310 configured to communicate wirelessly with mobile device 200. Imager 102 may capture and/or store in a memory storage device 308 image data representing one or more images captured by image sensor 304. In another example, memory storage device 308 may be disposed in mobile device 200. Image data may be communicated from imager 102 to mobile device 200 by wire line communication via conductive wire 204 and/or wireless communication link 312 via transmitter and/or receiver 310. Imager 102 may comprise a processor 314 configured to process image data. Alternatively, image data may be processed by a processor in mobile device 200.

In an example, imager 102 may comprise a microphone 306 configured to detect audio. Imager 102 may capture and/or store in memory storage device 308 audio data representing the audio detected by microphone 306. In another example, memory storage device 308 may be disposed in mobile device 200. The audio data may be communicated from imager 102 to mobile device 200 by wire line communication via conductive wire 204 and/or wireless communication link 270 via transmitter and/or receiver 310. Processor 314 may be configured to process audio data. Alternatively, audio data may be processed by a processor in mobile device 200.

In an example, imager 102 may draw power from a power source supplying mobile device 200. Alternatively, imager 102 may be powered by batteries 320. Batteries 320 may be disposable or rechargeable. Batteries 320 may be recharged when imager is plugged into mobile device 200 via conductive wire 204 and/or another charging method such as by connecting to a charger or by charging batteries 320 in separate standalone battery charger.

FIG. 4 illustrates an example of a mobile device 200 comprising an extendable imager 102. Mobile device 200 may comprise a slot 402. In an example, arm 104 may be configured to retract into a slot 402.

In an example, arm 104 may be configured to be extended and/or retracted, tilted and/or rotated manually. For example, a user may simply push and/or pull arm 104 in and/or out of slot 402. Arm 104 may be manually twisted such that imager 102 may face various directions. In an example, arm 104 may be manipulated manually to tilt.

In another example, arm 104 may be configured may be configured to automatically extend, retract, tilt and/or rotate. Extension and/or retraction of arm 104 may be actuated by an arm motor 404. Arm motor 404 may be configured to extend, retract, tilt and/or rotate arm 104 and may comprise a gear system 406.

In another example, motor 404 may comprise a variety of different and/or additional mechanical systems configured to actuate arm 104 including, a hydraulic system, a solenoid system, a spring system, a pneumatic system, a pulley system or the like or a combination thereof.

In an example, motor 404 may be configured to rotate arm 104. Arm 104 rotation may correspondingly rotate imager 102. For example, arm 104 may be configured to rotate imager 102 about 360 degrees. Such rotation may facilitate image capture by imager 102 in a variety of positions and may enable capture of panoramic image views.

In an example, mobile device 200 may comprise processor 410, arm controller 408 and transmitter and/or receiver 416. Arm controller 408 may be coupled to arm motor 404 and may be configured to control arm 104. Arm controller 408 may communicate commands and/or instructions to arm motor 404 by wire line communication via conductive wire 204 and/or wireless communication link 312 via transmitter and/or receiver 310 and transmitter and/or receiver 416. In another example, processor 410 may be configured to control arm motor 404.

In an example, imager 102 may be configured to automatically extend, retract, tilt and/or rotate. Extension and/or retraction of arm 104 may be actuated by an imager motor 414. Imager motor 414 may actuate imager 102 and may comprise a variety of mechanical actuator systems including, a gear system, a hydraulic system, a solenoid system, a spring system, a pneumatic system, a pulley system or the like or a combination thereof.

In an example, mobile device 200 may comprise imager controller 412. Imager controller 412 may be coupled to imager 102 and may be configured to trigger movement, image capture and/or audio recording by imager 102. Imager controller 412 may be configured to communicate commands and/or instructions to imager 102 and/or imager motor 414 by wire line communication via conductive wire 204 and/or wireless communication link 312 via transmitter and/or receiver 310 and/or transmitter and/or receiver 416. In another example, processor 314 and/or processor 410 may control imager 102 and/or imager motor 414.

In an example, imager controller 412 and/or arm controller 408 may be coupled to and/or in communication with each other. Imager controller 412 and/or arm controller 408 may be in communications with processor 410 and/or processor 314. Imager controller 412, arm controller 408 and/or processor 410 may be disposed in mobile device 200. Alternatively, imager controller 412 and/or arm controller 408 may be disposed in imager 102. Imager controller 412 and/or arm controller 408 may form a portion of processor 410 and/or processor 314. Imager controller 412 and/or arm controller 408 may be separate from processor 410 and/or processor 314.

In an example, processor 410 and/or processor 314 may be configured to coordinate image capture and audio capture by imager 102 and movement of arm 104 and/or imager 102. For example, processor 410 may be configured to receive image data, audio data, position data generated by a position sensor 420 and/or status data generated by imager controller 412 and/or arm controller 408 and/or processor 314. Position data may identify a position and/or direction imager 102 is facing. Status data may be any data related to image capture such as whether lens 302 is focused, flash is required, image sensor 304 is ready to capture an image and/or whether still, multiple or video images are to be captured, or the like or a combination thereof. Status data may also identify other whether microphone 306 is on/off, a memory 308 status, a battery 320 status, and/or the like or a combination thereof. Processor 410 may process image data, audio data, status data, position data, and/or the like or a combination thereof to time motion of arm 104 and/or imager 102 with image and audio capture.

In an example, transmitter and/or receiver 416 may be coupled to and/or in communication with processor 410. Transmitter and/or receiver 416 may send and/or receive data to/from any of imager 102, arm 104, imager controller 412, arm controller 408 and/or processor 410. For example, transmitter and/or receiver 416 may receive image and/or audio data, position data, status data and/or other imager data from imager 102 and may communicate image and/or audio data, position data, status data and/or other imager data to processor 410 to be processed.

FIG. 5 illustrates an example of a mobile device 200 comprising an extendable imager 102. Mobile device 200 may comprise one or more input/output devices such as actuators 502, 504, and 506. Actuators 502, 504 and/or 506 may comprise graphical user interface (GUI) soft buttons configured to be displayed on display 202. In another example, actuators 502, 504 and/or 506 may comprise any of a variety of devices or modules, such as, a button, a lever, a voice command module, a motion and/or position sensor, an image sensor, a touch sensor, a light sensor, a Global Positioning Sensor (GPS), an altitude sensor, or the like or a combination thereof. Imager controller 412, arm controller 408, processor 410 and/or processor 314 may be configured to receive an input via any of actuators 502, 504 or 506. Responsive to the input, imager controller 412, arm controller 408, processor 410 and/or processor 314 may be configured to take an action identified by the input, such as to trigger imager 102 to display and/or capture an image and/or play and/or capture audio. Responsive to the input, imager controller 412, arm controller 408, processor 410 and/or processor 314 may be configured to trigger various types of movement of imager 102 and/or arm 104 such as, extension, retraction, rotation and/or tilt.

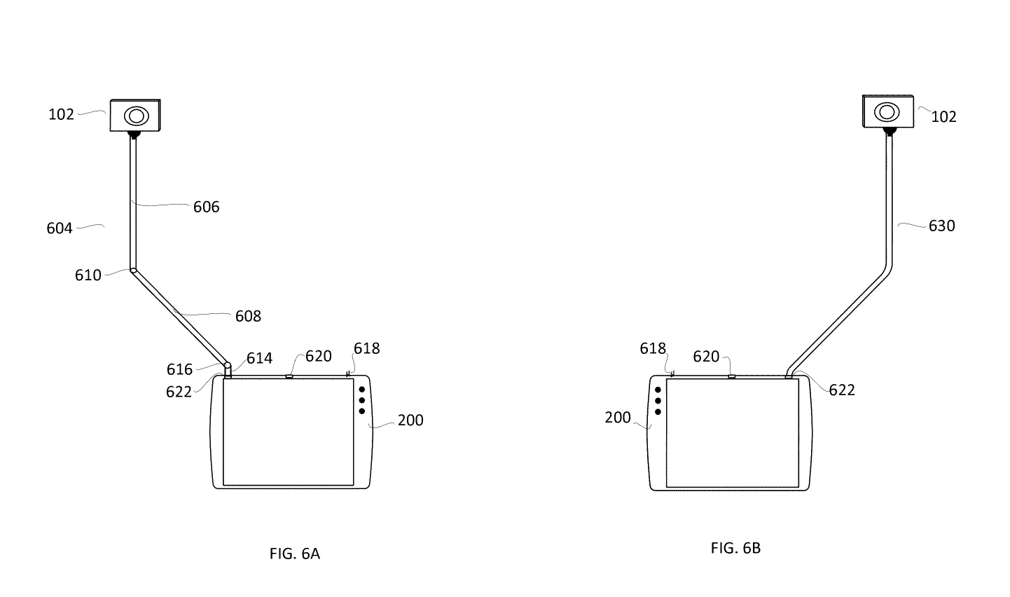

FIGS. 6A-6B illustrate examples of a mobile device 200 configured to extend and/or retract imager 102. FIG. 6A illustrates an example of mobile device 200 comprising an imager 102 disposed on an arm 604 wherein arm 604 is articulated. Arm 604 may comprise first arm segment 606 and second arm segment 608 coupled together at first connector 610. First arm segment 606 and second arm segment 608 may comprise any of a variety of materials such as titanium, aluminum, steel, carbon fiber, plastic, fiberglass, metal alloy and/or other material, or a combination thereof.

In an example, arm 604 may be articulated at a base portion 614 at second connector 616. First connector 610 and/or second connector 616 may comprise any of a variety of joints, hinges, pins, swivels and/or other connectors such as a ball-and-socket joint and/or a constant torque friction hinge, or the like or a combination thereof. Arm 604 may be configured to straighten to extend imager 102 and to fold to collapse. Arm 604 may be secured in a folded position by fastener 618 disposed on mobile device 200. Mobile device 200 may comprise more than one fastener 618 configured to secure arm 604. Fastener 618 may comprise any of a variety of devices or materials configured to hold arm 604 in position such as a clip, a magnet, Velcro®, a groove, and/or other fasteners, or a combination thereof.

In an example, imager 102 and arm 604 may form a part of mobile device 200. Imager 102 and arm 630 may be detachable from mobile device 200 wherein arm 630 may be inserted into and/or removed from slot 402 and/or a pre-existing port in mobile device 200 such as a USB port 620, a headphone jack 622, or other port, or a combination thereof.

FIG. 6B illustrates a mobile device 200 comprising an imager 102 disposed on an arm 630 wherein arm 630 may comprise a flexible material such as a malleable metal and/or thermoplastic, or a combination thereof. In an example, arm 630 may comprise one or more segments. Arm 630 may be configured to extend and/or retract into a specialized slot 402 or may be configured to fold or collapse. Arm 630 may be configured to be secured in position by fastener 618. Imager 102 and arm 630 may form a part of mobile device 200. Imager 102 and arm 630 may be detachable from mobile device 200 wherein arm 630 may be inserted into and/or removed from slot 402 and/or a pre-existing port in mobile device 200 such as a USB port 620, a headphone jack 622, or other port, or a combination thereof.

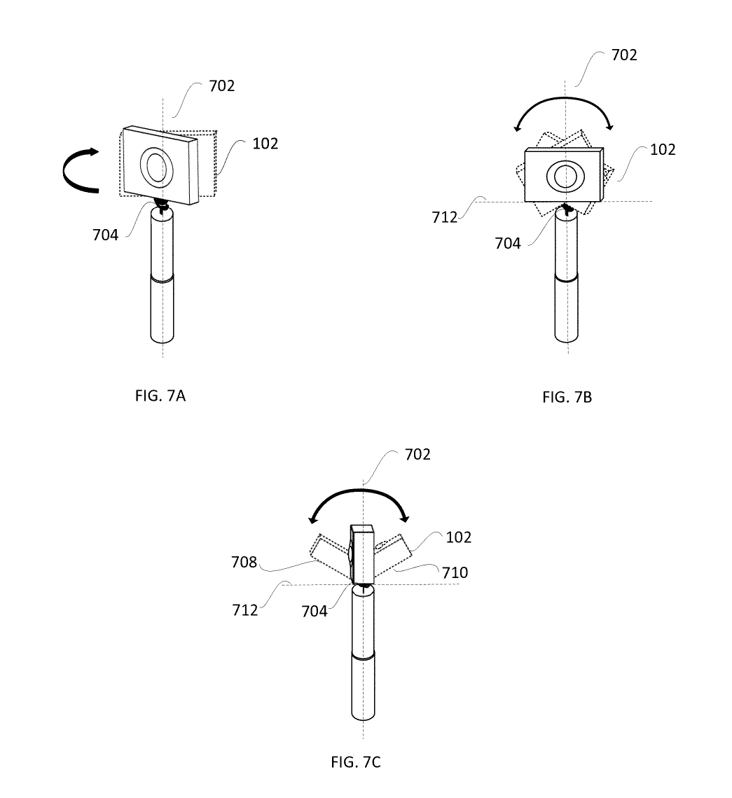

FIGS. 7A-7C depict various example ranges of motion of an extendable imager 102 configured to be coupled to a mobile device 200. FIG. 7A illustrates imager 102 which may be connected to arm 704 via connector 704. Connector 704 may be any of a variety of motors, connectors and/or fasteners, for example, a gear driven motor, a pin, a hinge, a bearing, a swivel, a gear-driven swivel, a ball-and-socket swivel, and/or a pressure swivel, or the like or a combination thereof. Connector 704 may be configured to rotate imager 102 manually and/or automatically about an axis 702. In an example, imager 102 may be configured to rotate about 360 degrees.

FIG. 7B illustrates an example of imager 102 which may be configured to tilt side-to-side manually and/or automatically in any plane parallel to axis 702 or may be restricted to a particular plane. In an example, imager 102 may be configured to tilt left or right between about zero to about 90 degrees from a starting position parallel to axis 712 about axis 702. In another example, imager 102 may be configured to tilt to only one side. Connector 704 may be configured to tilt imager 102 manually and/or automatically.

FIG. 7C illustrates an example of imager 102 including a front portion 708 and back portion 710. Imager 102 may be configured to tilt forward in the direction of front portion 708 and/or backward in a direction of back portion 710. Imager 102 may tilt forward and/or backward manually and/or automatically in any plane parallel to axis 702 or may be restricted to a particular plane. Imager 102 may be configured to tilt forward and/or backward between about +90 to about −90 degrees about axis 702 from a starting position parallel to axis 712 about axis 702. In another example, imager 102 may be configured to tilt only backward or forward. Connector 704 may be configured to tilt imager 102 forward and/or backward manually and/or automatically.

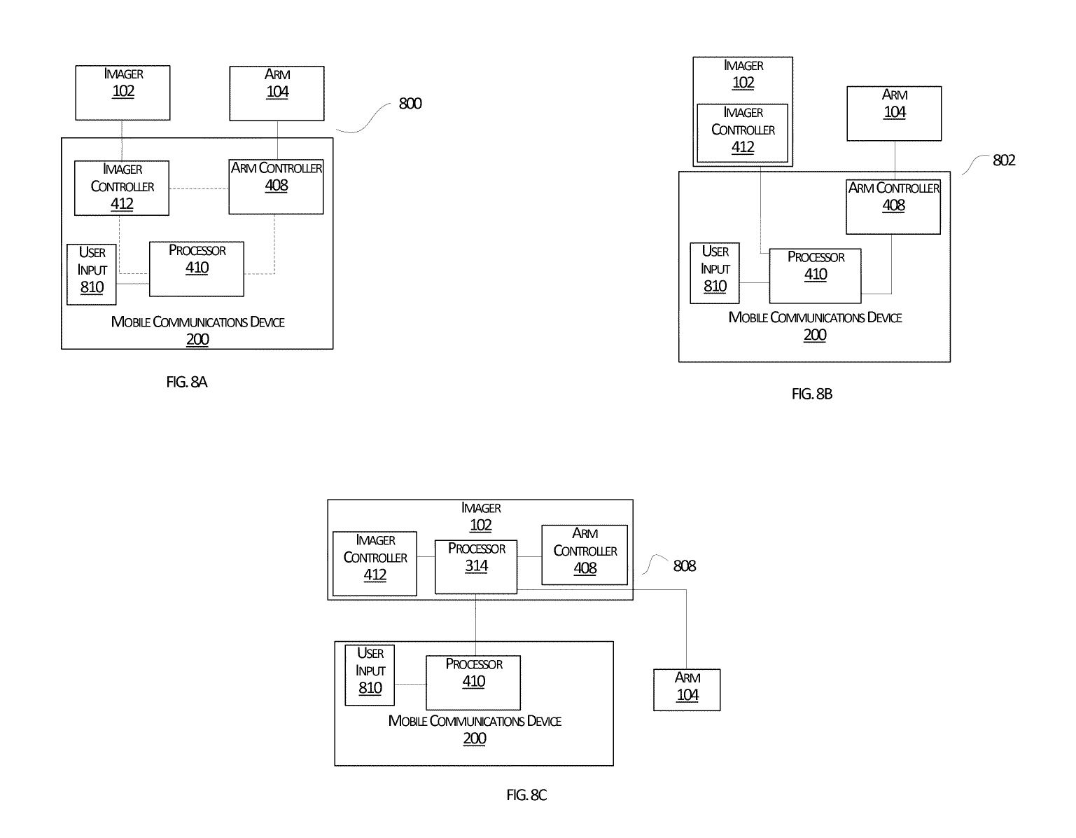

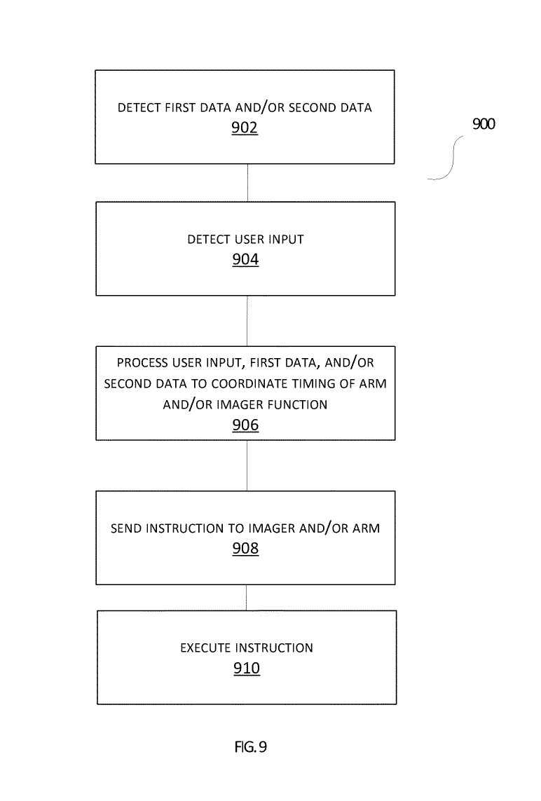

FIGS. 8A-8C illustrate a few of many possible examples of various extendable imager assemblies 800-804. Such assemblies 800-804 may include imager controller 412, arm controller 408, processor 314 and/or processor 410 within imager 102 and/or mobile device 200.

FIG. 8A illustrates an example of an extendable imager assembly 800 including imager 102, arm 104, imager controller 412, arm controller 408, processor 410 and user input module 810. Imager 102 may be coupled to imager controller 412. Arm 104 may be coupled to arm controller 408. Arm controller 408 and imager controller 412 may be coupled together such that data associated with events and/or actions controlled by the arm controller 408 may be communicated from arm controller 408 to imager controller 412 and data associated with events and/or actions controlled by the imager controller 412 may be communicated from imager controller 220 to arm controller 408. Imager controller 412 and arm controller 408 may be configured to time respective arm 104 and imager 102 events and/or actions based on the data associated with events and/or actions controlled by imager controller 412 and/or the data associated with events and/or actions controlled by arm controller 408.

In an example, arm controller 408 and imager controller 412 may be coupled to processor 410. Data associated with events and/or actions controlled by arm controller 408 may be communicated from arm controller 408 to processor 410. Data associated with events and/or actions controlled by imager controller 412 may be communicated to processor 410. Processor 260 may be configured to time respective arm 104 and imager 102 events and/or actions based on the data associated with events and/or actions controlled by imager controller 412 and the data associated with events and/or actions controlled by arm controller 408. Processor 410 may be configured to send instruction and/or commands to imager controller 412 and/or arm controller 408 to facilitate timing of the respective events and/or actions of imager 102 and arm 104.

In an example, imager controller 412, arm controller 408 and processor 410 may reside within mobile device 200. Data associated with events and/or actions controlled by arm controller 408 may be communicated from arm controller 408 to processor 410. Data associated with events and/or actions controlled by imager controller 412 may be communicated from imager controller 412 to processor 410. Processor 410 may receive user input via user input module 810 configured to trigger image and/or audio capture, events and/or actions controlled by imager controller 412, and/or events and/or actions controlled by arm controller 408, or the like or combinations thereof. Processor 410 may be configured to trigger and/or coordinate respective arm 104 and imager 102 events and/or actions based on user input 810, data associated with events and/or actions controlled by imager controller 412 and data associated with events and/or actions controlled by arm controller 408. Processor 410 may send instruction and/or commands to imager controller 412 and/or arm controller 408 to coordinate timing of respective events and/or actions of imager 102 and arm 104.

FIG. 8B illustrates an example of an extendable imager assembly 802 including processor 410, imager 102, arm 104, imager controller 412, arm controller 408 and mobile device 200. Imager controller 412 may reside on imager 102. Arm controller 408 and processor 410 may reside within mobile device 200.

FIG. 8C illustrates an example of an extendable imager assembly 804 including processor 410, processor 314, imager 102, arm 104, imager controller 412, arm controller 408 and mobile device 200. Arm controller 408 and imager controller 412 may be coupled via processor 314. Imager controller 412, processor 314 and arm controller 408 may reside on imager 102. Processor 410 may reside on mobile device 200. Data associated with events and/or actions controlled by arm controller 408 may be communicated from arm controller 408 to processor 314. Data associated with events and/or actions controlled by imager controller 412 may be communicated from imager controller 412 to processor 314. Data associated with events and/or actions controlled by arm controller 408 and data associated with events and/or actions controlled by imager controller 412 may be communicated from processor 314 to processor 410. Processor 410 may receive user input 810 configured to trigger image and/or audio capture, events and/or actions controlled by imager controller 412, and/or events and/or actions controlled by arm controller 408, or the like or combinations thereof. Processor 410 may be configured to coordinate timing of respective arm 104 and imager 102 events and/or actions based on user input 810, the data associated with events and/or actions controlled by imager controller 412 and/or the data associated with events and/or actions controlled by arm controller 408. Processor 410 may send instruction and/or commands to processor 314. Processor 314 may send imager controller 412 and/or arm controller 408 instructions and/or commands to facilitate coordinating the respective events and/or actions of imager 102 and arm 104.

FIG. 9 illustrates a process 900 for controlling functions of an extendable imager 102 coupled to a mobile device 200 via an arm 104 for capturing an image and/or audio with imager 102. Process 900 may begin at operation 902, where processor 410 may detect a user input 810, first data, and/or second data. First data may be related to imager 102 and/or second data may be related to arm 104. First data may be associated with a status, one or more actions, events and/or positions, or a combination thereof associated with imager 102. Second data may be associated with a status, one or more actions, events and/or positions, or a combination thereof associated with arm 104. User input 810 may be configured to trigger one or more actions and/or events associated with imager 102 and/or one or more actions and/or events associated with arm 104. At operation 906, processor 410 may process user input 810, first data and/or second data to coordinate timing of one or more functions of arm 104 and/or imager 102. At operation 908, processor 410 may send an instruction to imager controller 412 and/or arm controller 408 based on user input 810, first data, and/or second data. At operation 910, imager controller 412 and/or arm controller 408 may execute the instruction. In an example, the instruction may be configured to trigger a movement such as, rotation, tilt, extension and/or retraction, of arm 104 and/or imager 102. The instruction may be configured to trigger imager 102 to capture one or more images and/or to capture audio. The instruction may be configured to coordinate the timing of events and/or actions of imager 102 and/or arm 104. In an example, such coordinated timing of events and/or actions of imager 102 and/or arm may enable capture of a panoramic picture by imager 102 wherein imager 102 may capture multiple images at slightly varied angles of rotation by arm 104.

In an example, imager controller 412 and/or arm controller 408 may receive the one or more instructions from processor 410 to command arm motor 404 and/or imager motor 414 to move arm 104 and/or imager 102 based on user input 810. Imager controller 412 and/or arm controller 408 may send one or more commands to arm motor 404 and/or imager motor 414 to control arm 104 and/or imager 102 based on the one or more instructions received from processor 410.

Disclosed herein is a mobile device comprising, an imager configured to capture an image responsive to a command from the mobile device, and an arm coupled to the imager, the arm capable configured to extend the imager from a surface of the mobile device. The mobile device further comprises a communication interface between the arm and the mobile device. The mobile device further comprises at least one motor configured to move the arm and/or the imager. The mobile device further comprises an arm controller configured to control the arm to automatically extend, retract, rotate, or tilt the imager, or a combination thereof and an imager controller configured to control the imager to automatically capture an image and/or audio, extend, retract, rotate, or tilt the imager, or a combination thereof, wherein the imager controller and the arm controller are configured to coordinate timing of one or more actions controlled by the imager controller with one or more actions controlled by the arm controller. The mobile device further comprises a processor configured receive user input data, arm data from an arm controller and imager data from an imager controller, wherein the processor is configured to coordinate timing of one or more actions controlled by the imager controller with one or more actions controlled by the arm controller based on the user input data, arm data and/or imager data, wherein the processor is further configured to send instructions to the image controller and/or the arm controller based on the user input data, imager data and arm data. The mobile device is at least one of a mobile phone, a tablet, a notebook, a personal computer, a laptop computer, an Ultrabook™ system, a slate device or a wearable computer.

Disclosed herein, is an imager comprising an image sensor configured to capture an image responsive to a command from a mobile device and an arm coupled to the image sensor, the arm configured to attach to the mobile device and extend the imager from a surface of the mobile device. The imager further comprises an imager controller configured to control the imager to automatically capture an image and/or audio, extend, retract, rotate, or tilt the imager, or a combination thereof. The imager further comprises an arm controller configured to control the arm to automatically extend, retract, rotate, or tilt the imager, or a combination thereof, wherein the imager controller and the arm controller are configured to coordinate timing of one or more actions controlled by the imager controller with one or more actions controlled by the arm controller. The imager further comprises a processor configured receive user input data, arm data from an arm controller and imager data from an imager controller, wherein the processor is configured to coordinate timing of one or more actions controlled by the imager controller with one or more actions controlled by the arm controller based on the user input data, arm data and/or imager data. The processor is further configured to send instructions to the image controller and/or the arm controller based on the user input data, imager data and arm data. The imager further comprises wherein the mobile device is at least one of a mobile phone, a tablet, a notebook, a personal computer, a laptop computer, an Ultrabook™ system, a slate device or a wearable computer. The imager further comprises wherein the arm is configured to be coupled to the mobile device via a port of the mobile device.

Disclosed herein is a process for controlling functions of an extendable imager coupled to a mobile device via an extendable arm comprising detecting, by a processor in the mobile device, a user input, first data associated with the arm, and/or second data associated with the imager, processing, by the processor, the user input, the first data, and/or the second data, sending, by the processor, one or more instructions to coordinate timing of an arm function and/or an imager function based on the user input, the first data, and/or the second data and executing, by the imager and/or the arm, the one or more instructions. The process further comprises wherein the first data is configured to identify a status, position, and/or action of the imager and/or the second data is configured to identify a status, position, and/or action of the arm. The processor further comprises wherein the user input is configured to trigger one or more actions associated with imager and/or one or more actions associated with arm. The processor further comprises wherein the instruction is sent to an imager controller configured to control the imager and/or an arm controller configured to control the arm.

Disclosed herein is a system for operating an extendable imager coupled a mobile device via an extendable arm comprising a means for detecting a user input, first data associated with the arm, and/or second data associated with the imager, means for processing the user input, the first data, and/or the second data, means for sending one or more instructions to coordinate timing of an arm function and/or an imager function based on the user input, the first data, and/or the second data and means for executing the one or more instructions. The system further comprises wherein the first data is configured to identify a status, position, and/or action of the imager and/or the second data is configured to identify a status, position, and/or action of the arm.

Disclosed herein is a non-transitory computer-readable medium comprising instructions to control functions of an extendable imager coupled to a mobile device via an extendable arm that, in response to execution of the instructions by a computing device, enable the computing device to detect a user input, first data associated with the arm, and/or second data associated with the imager, process the user input, the first data, and/or the second data, send one or more instructions to coordinate timing of an arm function and/or an imager function based on the user input, the first data, and/or the second data and execute the one or more instructions. The non-transitory computer-readable medium further comprises, wherein the first data is configured to identify a status, position, and/or action of the imager and/or the second data is configured to identify a status, position, and/or action of the arm. The non-transitory computer-readable medium further comprises, wherein the user input is configured to trigger one or more actions associated with imager and/or one or more actions associated with arm. The non-transitory computer-readable medium further comprises, wherein the mobile device is at least one of a mobile phone, a tablet, a notebook, a personal computer, a laptop computer, an Ultrabook™ system, a slate device or a wearable computer. The non-transitory computer-readable medium further comprises, wherein the instruction is sent to an imager controller configured to control the imager and/or an arm controller configured to control the arm. Disclosed herein is a machine-readable medium including code, when executed, to cause a machine to perform the method/process as described, an apparatus comprising means to perform a method/process as described herein and/or machine-readable storage including machine-readable instructions, when executed, to implement a method or realize an apparatus as described herein.

The system and apparatus described above may use dedicated processor systems, micro controllers, programmable logic devices, microprocessors, or the like, or any combination thereof, to perform some or all of the operations described herein. Some of the operations described above may be implemented in software and other operations may be implemented in hardware. One or more of the operations, processes, and/or methods described herein may be performed by an apparatus, a device, and/or a system substantially similar to those as described herein and with reference to the illustrated figures.

In an example, processor 316 and/or 410 may execute instructions or “code” stored in memory. The memory may store data as well. In an example, processor 316 and/or 410 may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

In an example, processor 316 and/or 410 memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processor 316 and/or 410 may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a conventional rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or the like, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

Having described and illustrated the principles of examples, it should be apparent that the examples may be modified in arrangement and detail without departing from such principles. We claim all modifications and variation coming within the spirit and scope of the following claims.

we claim:

1. A mobile device comprising:
an imager configured to capture an image responsive to a command from the mobile device; and
an arm coupled to the imager, the arm configured to extend the imager from a surface of the mobile device.

2. The mobile device of claim 1, further comprising a communication interface between the arm and the mobile device.

3. The mobile device of claim 1, further comprising at least one motor configured to move the arm and/or the imager.

4. The mobile device of claim 1, further comprising:
an arm controller configured to control the arm to automatically extend, retract, rotate, or tilt the imager, or a combination thereof; and
an imager controller configured to control the imager to automatically capture an image and/or audio, extend, retract, rotate, or tilt the imager, or a combination thereof,
wherein the imager controller and the arm controller are configured to coordinate timing of one or more actions controlled by the imager controller with one or more actions controlled by the arm controller.

5. The mobile device of claim 1, further comprising a processor configured receive user input data, arm data from an arm controller and imager data from an imager controller, wherein the processor is configured to coordinate timing of one or more actions controlled by the imager controller with one or more actions controlled by the arm controller based on the user input data, arm data and/or imager data, wherein the processor is further configured to send instructions to the image controller and/or the arm controller based on the user input data, imager data and arm data.

6. The mobile device of claim 1, wherein the mobile device is at least one of a mobile phone, a tablet, a notebook, a personal computer, a laptop computer, an Ultrabook™ system, a slate device or a wearable computer.

7. An imager comprising:
an image sensor configured to capture an image responsive to a command from a mobile device; and
an arm coupled to the image sensor, the arm configured to:
attach to the mobile device; and
extend the imager from a surface of the mobile device.

8. The imager of claim 7, further comprising an imager controller configured to control the imager to automatically capture an image and/or audio, extend, retract, rotate, or tilt the imager, or a combination thereof.

9. The imager of claim 7, further comprising an arm controller configured to control the arm to automatically extend, retract, rotate, or tilt the imager, or a combination thereof, wherein the imager controller and the arm controller are configured to coordinate timing of one or more actions controlled by the imager controller with one or more actions controlled by the arm controller.

10. The imager of claim 9, further comprising a processor configured receive user input data, arm data from an arm controller and imager data from an imager controller, wherein the processor is configured to coordinate timing of one or more actions controlled by the imager controller with one or more actions controlled by the arm controller based on the user input data, arm data and/or imager data.

11. The imager of claim 10, wherein the processor is further configured to send instructions to the image controller and/or the arm controller based on the user input data, imager data and arm data.

12. The imager of claim 7, wherein the mobile device is at least one of a mobile phone, a tablet, a notebook, a personal computer, a laptop computer, an Ultrabook™ system, a slate device or a wearable computer.

13. The imager of claim 7, wherein the arm is configured to be coupled to the mobile device via a port of the mobile device.

14. A process for controlling functions of an extendable imager coupled to a mobile device via an extendable arm comprising:
detecting, by a processor in the mobile device, a user input, first data associated with the arm, and/or second data associated with the imager;
processing, by the processor, the user input, the first data, and/or the second data;
sending, by the processor, one or more instructions to coordinate timing of an arm function and/or an imager function based on the user input, the first data, and/or the second data; and
executing, by the imager and/or the arm, the one or more instructions.

15. The process of claim 14, wherein the first data is configured to identify a status, position, and/or action of the imager and/or the second data is configured to identify a status, position, and/or action of the arm.

16. The process of claim 14, wherein the user input is configured to trigger one or more actions associated with imager and/or one or more actions associated with arm.

17. The process of claim 14, wherein the instruction is sent to an imager controller configured to control the imager and/or an arm controller configured to control the arm.

18. A non-transitory computer-readable medium comprising instructions to control functions of an extendable imager coupled to a mobile device via an extendable arm that, in response to execution of the instructions by a computing device, enable the computing device to:
detect a user input, first data associated with the arm, and/or second data associated with the imager;
process the user input, the first data, and/or the second data;
send one or more instructions to coordinate timing of an arm function and/or an imager function based on the user input, the first data, and/or the second data; and
execute the one or more instructions.

19. The non-transitory computer-readable medium of claim 18, wherein the first data is configured to identify a status, position, and/or action of the imager and/or the second data is configured to identify a status, position, and/or action of the arm.

20. The non-transitory computer-readable medium of claim 18, wherein the user input is configured to trigger one or more actions associated with imager and/or one or more actions associated with arm.

21. The non-transitory computer-readable medium of claim 18, wherein the mobile device is at least one of a mobile phone, a tablet, a notebook, a personal computer, a laptop computer, an Ultrabook ^{TM} system, a slate device or a wearable computer.

22. The non-transitory computer-readable medium of claim 18, wherein the instruction is sent to an imager controller configured to control the imager and/or an arm controller configured to control the arm.
